(19) United States
(12) Patent Application Publication
(10) Pub. No.: US 2011/0016108 A1
(43) Pub. Date: Jan. 20, 2011

(54) SEARCH RESULT PLUSBOX INCLUDING RESTRICTED RESULTS

(76) Inventors: Matias Pelenur, Brooklyn, NY (US); Samarth Keshava, New York, NY (US); Jeremy Silber, New York, NY (US)

Correspondence Address: FISH & RICHARDSON P.C., PO BOX 1022, MINNEAPOLIS, MN, 55440-1022, US

(21) Appl. No.: 12/838,909

(22) Filed: Jul. 19, 2010

Related U.S. Application Data
(60) Provisional application No. 61/226,909, filed on Jul. 20, 2009.

(51) Int. Cl. G06F 17/30

(52) U.S. Cl. 707/722; 707/E17.009; 707/E17.014

(57) ABSTRACT

Systems, methods and computer program products for generating initial search results based on a search query and additional search results using a control element are described. The control element, when activated by a user of a client device, may execute a call to a server which fetches the additional results to the client device. Alternatively, the additional results may be pre-populated and displayed only when the control element is activated. In some implementations, the additional results may include results that are from the same source as the initial search results.

### CROSS-REFERENCE TO RELATED APPLICATIONS

This application is a utility application which claims the benefit of Provisional U.S. Application No. 61/226,909, filed on Jul. 20, 2009. The contents of this provisional application is incorporated herein by reference in its entirety.

### TECHNICAL FIELD

The subject matter of this application is generally related to information retrieval.

### BACKGROUND

Search results can be identified by a search engine in response to a search query by a user. The search query can include one or more search terms (e.g. keywords), and the search engine can match the terms in the search query to a corpus of pre-stored web pages to generate a set of relevant search results. The search engine can rank the search results based on, for example, the search terms in the query. Web pages that contain the user's search terms are “hits” and are returned to the user in the form of links.

Traditional search engines can struggle when deciding between providing users with a greater number of results from a single, highly relevant website (result quality) and providing users with diversified results from various web sites (result diversity). To overcome this technical challenge, traditional search engines limits the display of the results from a particular host or domain. Searchers wishing to drill down into a particular web site use a site restriction option and conduct a follow on search to focus a specific search within that web site.

### SUMMARY

Systems, methods and computer program products for generating initial search results based on a search query and additional search results using a control element are described. The control element, when activated by a user of a client device, may execute a call to a server which fetches the additional results to the client device. Alternatively, the additional results may be delivered along with the traditional search results but hidden until the control element is activated. In some implementations, the additional results may include results that are from the same source as the initial search results.

In some implementations, a method may be provided that includes receiving a query including one or more keywords from a client device, identifying initial results associated with the one or more keywords, identifying a subset of the initial results including one or more initial results from a first source, and generating display data for displaying the initial results at the client device including display data associated with the one or more initial results including at least a predetermined number of the subset and a control element associated with the subset, where the control element is selectable by a user of the client device for enabling a presentation of additional search results on the client device responsive to the query but restricted to the first source.

In some implementations, a method may be provided that includes issuing a first query including one or more keywords, receiving and displaying initial query results associated with the one or more keywords in response to issuing the query, displaying a control element proximate to one of the initial query results, and in response to receiving a selection of the control element, displaying additional query results from the same source as the one initial query result.

In some implementations, a method may be provided that includes determining, by one or more servers, initial results for a search query based on relevance to keywords associated with the search query, filtering, by the one or more servers, the initial results including limiting a number of results to display from a first source, the filtered initial results including a first result associated with the first source, and generating, by the one or more servers, display data including the first result including providing a control element with the first result, the control element activatable to provide additional results from the first source.

In some implementations, a method may be provided that includes receiving a query including one or more keywords, determining, by one or more servers, initial results for the query based on relevance to the keywords associated with the query, filtering, by one or more servers, the initial results including limiting a number of results to display from a first source, the filtered initial results including a first result associated with the first source, and automatically generating, by one or more servers, display data including the first result including providing a control element with the first result, the control element activatable to provide additional search results associated with the query that are from the first source without requiring a user of the client device to initiate another search.

In some implementations, a system may be provided that includes a search system configured to provide relevant initial search results to a query, the search system including a query engine to receive the query including one or more keywords from a client device and identify relevant initial results associated with the one or more keywords, a filter for providing a limited number of initial results from a first source producing filtered initial results, a control engine that generates a control element associated with the first source, the control element activatable to identify additional query results associated with the first source, and a display generator that generates display data for displaying the filtered initial results and the control element, and provides the display data including the control element to the client device.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online search system.

FIG. 2 is a block diagram showing an example communication between a server device and a client device.

FIG. 3A is an example screen shot showing a plusbox in a closed state.

FIG. 3B is an example screen shot showing a minusbox in an open state.

FIG. 4 is a flow diagram of an example process for enabling a presentation of additional search results on a client device.

FIG. 5 is a flow diagram of an example process for displaying additional search results on a client device.

FIG. 6 is a flow diagram of an example process for generating display data including a control element and additional search results.

FIG. 7 is a flow diagram of an example process for generating display data including a first result and a control element associated with the first result.

FIG. 8 is a schematic diagram of an example computer system that can be utilized to implement the systems and methods described herein, as either a client device or as a server device or plurality of server devices.

### DETAILED DESCRIPTION

### Overview

Systems, methods, computer program products and apparatus are described for delivering relevant content to a user. The user may provide a search query at a client device. One or more servers may provide relevant search results. In some implementations, a server may execute, in response to the search query a restricted search for any source that has multiple hits resulting from the search query. A source may include a host, a domain, a content provider, a web publisher, a web site, a cluster or other grouping of content. Additional results generated from the restricted search (e.g., site specific search) may be automatically delivered to the user upon request without requiring an additional search or pre-populated but hidden from view. The additional results may be displayed only when the user desires to view the additional results after viewing the initial search results. For example, to view the additional results, the user may activate a control element that is provided along with the initial results as will be discussed in greater detail below.

To accomplish such, the server may determine whether the initial search results reveal that multiple results are linked to a same source (e.g., where the initial search results come from a same domain, host, content provider or web publisher). In some implementations, only a subset of the hits linked to the same source is displayed (e.g., only two results linked to the same source are displayed). The remaining results (e.g., the remaining elements in the set of results associated with the source) may be included as additional results for presentation when the control element is activated. If desired, the additional results may be ranked prior to presentation based on factors such as, without limitation, relevancy, popularity, authoritativeness, and the like. The additional results also may be subject to further processing prior to presentation such as, without limitation, sorting, removing duplicates, merging like results, grouping results by hierarchy, or the like. As an example, search results associated with the host name “www.stanford.edu” may be grouped together, while search results linked to “www.berkeley.edu” may be grouped together but separate from the group containing the search results bearing the host name “www.stanford.edu”. The additional results may be determined automatically at the time when the user submits the original search query. In some implementations, the additional results may be automatically generated without the need for the user to execute a subsequent search, such as upon receiving a user indication (e.g., by opening a plusbox) that the additional results are desired. A plusbox may be a user interface feature that allows the user see more information about individual search results. For example, the user may enter “high speed printer” as an initial search query and receive five search results from company “X” pertaining to printer products and printer accessories sold by company “X” on company X's online store. Instead of displaying all five search results, two of the five search results may be presented to the user along with a control element (e.g., a “plusbox”) within or proximate to (e.g., in time or space) the two search results being displayed. Upon activating the control element (e.g., opening or clicking on the plusbox), the user may view the remaining three search results from company “X” on a same results page along with the two displayed search results.

In some implementations, an action prompt (e.g., a line of text such as “Show more results”) may be displayed together with the control clement near the initial search result for which the control element is displayed. The action prompt, when activated (e.g., by clicking or selecting) by the user, may execute a hidden programming code. The hidden programming code may execute a site restricted search request in the background to obtain additional results linked to the same source, with no immediate visible changes to the user. After identifying and loading the additional results, javascripts may be executed to copy the additional results into the initial search results page for presentation. As discussed above, the additional results may be generated in real time when the user activates the control element (e.g., opens the plusbox or selects the action prompt), or may be determined coincident with the initial search results, presented with the initial search results, and hidden from view.

### System Overview

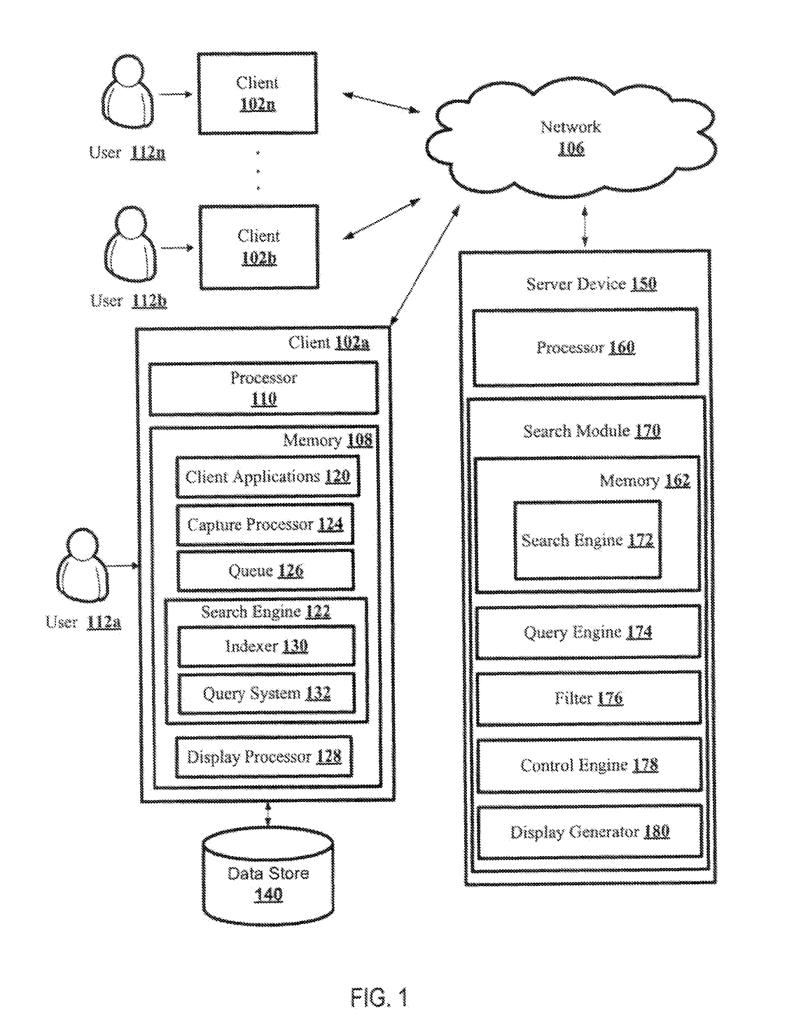

FIG. 1 is a block diagram of an example online search system 100. The system 100 may be used to provide search results in response to, for example, a search query. Referring to FIG. 1, the system 100 may include multiple client devices 102a-102n in communication with one or more server devices (e.g., server device 150) over a wired or wireless network 106. The network 106 may be the Internet, an intranet, or other conventional local networks.

### Client Device

As shown in FIG. 1, each client device 102a-102n may include a random access memory (RAM) 108 coupled to a processor 110. The processor 110 may be used to execute computer-executable program instructions stored in memory 108. The processor 110 may include a microprocessor, an ASIC, a state machine, or other conventional processors. The processor 110 may include (or may be in communication with) media (e.g., computer-readable media) which stores instructions that, when executed by the processor 110, cause the processor 110 to perform the steps of the methods described herein. Examples of computer-readable media may include, but are not limited to, an electronic, optical, magnetic, or other storage or transmission device capable of providing the processor 110 with computer-readable instructions. Examples of suitable computer readable storage medium may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may include programming code from any suitable computer-programming language, including, for example, C, C++, Visual Basic, Java, Python, Perl, and JavaScript.

Client devices 102a-102n may be connected to the network 106 as shown, or can be stand-alone machines. Client devices 102a-102n may also include a number of external or internal devices such as a mouse, a CD-ROM, DVD, a keyboard, a display, or other input or output devices. Examples of client devices 102a-102n may include personal computers, digital assistants, personal digital assistants, cellular phones, mobile phones, smart phones, pagers, digital tablets, laptop computers, Internet appliances, and other processor-based devices. In general, the client devices 102a-102n may be any type of processor-based platform that operates on any operating system, such as, without limitation, Microsoft® Windows® or Linux capable of supporting one or more client application programs. For example, the client device 102a may be a personal computer executing client application programs (e.g., client applications 120). The client applications 120 may be contained in the memory 108 and may include, for example, a word processing application, a spreadsheet application, an e-mail application, an instant messenger application, a presentation application, an Internet browser application, a calendar/organizer application, and any other application capable of being executed by a client device.

The user 112a may interact with various client applications 120 and articles associated with the client applications 120 via input and output devices of the client device 102a. Such articles may include, for example, word processor, spreadsheet, presentation, e-mail, instant messenger, database, and other client application program content files or groups of files, web pages of various formats, such as HTML, XML, XHTML, Portable Document Format (PDF) files, and audio files, video tiles, or any other documents or groups of documents or information of any type whatsoever.

The memory 108 also may include a capture processor 124, a queue 126, and a search engine 122. The client device 102a also may include, or be in communication with, a data store 140. The search engine 122 can receive a search query from the user 112a or generate an implicit query and retrieve information from the data store 140 in response to the query. The data store 140 may include a computer-readable media. The data store 140 may be integrated with the client device 102a (e.g., in the form of a hard drive) or may be external to the client device 102a (e.g., in the form of an external hard drive or on another data storage device accessed through the network 106). The data store 140 may include one or a combination of processes for storing data including without limitation, arrays, hash tables, lists, and the like.

The search engine 122 of the client device 102a also may include an indexer 130, a query system 132, and a formatter 134. Real time events may be provided by the queue 126 to the query system 132 upon request to provide the query system 132 with information concerning current user context. The queue 126 may also notify the query system 132 and the indexer 130 when new events are available. Real time events may include contextual and indexable events.

The user 112a may input an explicit query into a search engine interface displayed on the client device 102a, which may be received by the search engine 122. The search engine 122 also may generate an implicit query based on a current user context or state, which can be determined by the query system 132 from contextual real time events. Based on the query, the query system 132 may locate relevant information in the data store 140 and provide a set of results. The set of results may include article identifiers identifying articles associated with the client applications 120 or client articles stored in the data store 140. Client articles stored in the data store 140 may include articles associated with the user 112a or client device 102a (e.g., word processing documents, previously viewed web pages and any other article associated with the client device 102a or user 112a). In some implementations, the set of results also may include identifiers identifying articles located on the network 106 or network articles located by a search engine on a server device 150 (as will be discussed in greater detail below). Network articles may include articles located on the network 106 not previously viewed or otherwise referenced by the user 112a (e.g., web pages not previously viewed by the user 112a).

The set of results further may include one or more article identifiers. An article identifier may be, for example, a uniform resource locator (URL), a file name, a link, an icon, a path for a local file, or anything else that identifies an article.

Through the client devices 102a-102n, users 112a-112n may communicate over the network 106 with each other and with other systems and devices coupled to the network 106. The server device 150 also may be coupled to the network 106. The search engine 122 of the client device 102a may transmit a search query containing an explicit or implicit query or both to the server device 150. Users 112a-112n also may enter a search query in a search engine interface (e.g., via a browser), which may be transmitted to the server device 150.

### Server Device

The server device 150 may include a server executing a search engine application program, such as the Google™ search engine. Similar to client devices 102a-102n, the server device 150 may include a processor 160 coupled to a computer-readable memory 162. The server device 150, depicted as a single computer system, may be implemented as a network of computer processors. Examples of a server device 150 may include servers, mainframe computers, networked computers, a processor-based device, and similar types of systems and devices. In some implementations, the server device 150 may have previously performed a crawl of the network 106 to locate articles, such as web pages, stored at other devices or systems connected to the network 106, and indexed the articles in the memory 162 or on another data storage device.

The server device 150 also may include a search module 170. The search module 170 may include a memory 162. Programs stored in the memory 162 may include one or more search engine application programs such as a search engine 172. The search engine 172 may be used to locate relevant information in response to a search query received from any one of the client devices 102a-102n. The search engine 172 then may provide the search results to the client devices 102a-102n via the network 106. The search results may include one or more article identifiers. As discussed above, an article identifier may be, for example, a uniform resource locator (URL), a file name, a link, an icon, a path for a local file, or anything else that identifies an article.

The search module 170 further may include a query engine 174, a filter 176, a control engine 178 and a display generator 180. As will be discussed in greater detail below, the search module 170 may be configured to provide initial search results to a client device 102a-102n in response to a query submitted by the client device 102a-102n. The query engine 174 may receive the query including one or more keywords from the client device 102a-102n, and identify initial search results associated with the one or more keywords. The filter 176 may then filter and limit the number of initial search results that are to be displayed in a results page.

In some implementations, the filter 176 may parse through the initial search results to identify one or more results from a same source (e.g., from a same host, domain, web site, content provider or web publisher). For example, the filter 176 may identify, among the initial search results, one or more results that are hyperlinked to the same content provider. In some implementations, the filter 176 may analyze the article identifiers (e.g., a URL) associated with the initial search results, and based on the article identifiers, identify results that are from the same source such as the same host, domain, web site, content provider or web publisher (e.g. site restriction). A portion of the identified results may be output along with a control element. Additional results (e.g., those results that have been filtered out) may then be output as additional results to be displayed when the user 112a-112n requests the presentation of the additional results. In general, the filter 176 may limit a number of the initial search results from the same source to be displayed on the client device 102a-102n.

In some implementations, instead of displaying all of the additional results at once on the initial search results page, a control element (e.g., a plusbox) may be presented to the user 112a-112n. The control clement, when activated by the user 112a-112n, may display the additional results from the same source without requiring the user 112a-112n to initiate another search to view those additional results. The control element may be provided by the control engine 178, and the control element may be presented within or proximate to (e.g., in time or space) the initial search result using the display generator 180. The display generator 180 may generate display data for displaying the additional results and the control element, and provide the display data and the control clement to the client device 102a-102n.

In some implementations, an action prompt (e.g., a line of text such as “Show more results from www.xyz.com”) may be presented in the vicinity of or as part of the control element to alert the user 112a-112n that additional results from the same source are available and may be viewed by activating the control element. For example, if the user 112a-112n is interested in viewing additional results from the same source after viewing the initial search result displayed on the initial search results page, the user 112a-112n may activate the control element (e.g., open the plusbox) to reveal the additional results from that particular source. Clicking on or selecting the action prompt may be an alternative way for the user to reveal the additional results. After the plusbox is opened or the action prompt is selected, the presentation of the control element may be changed (e.g., the plusbox may be changed to a minusbox) and the action prompt may be changed (e.g., from “Show more results” to “Hide more results”) to alert the user 112a-112n that the additional results may be collapsed in the initial search results page.

### Plusbox for Displaying Additional Search Results

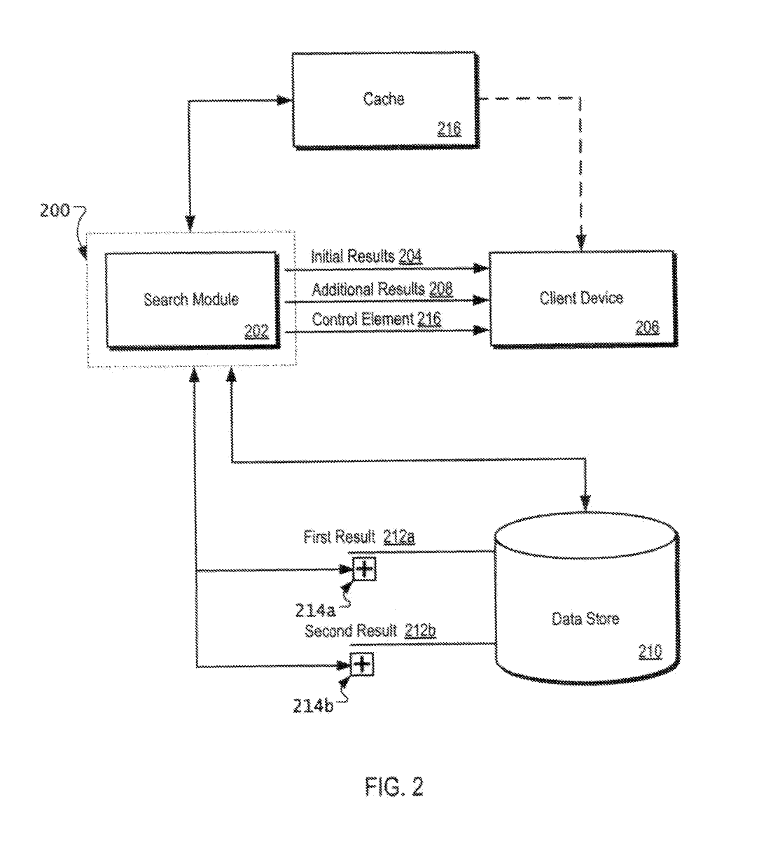

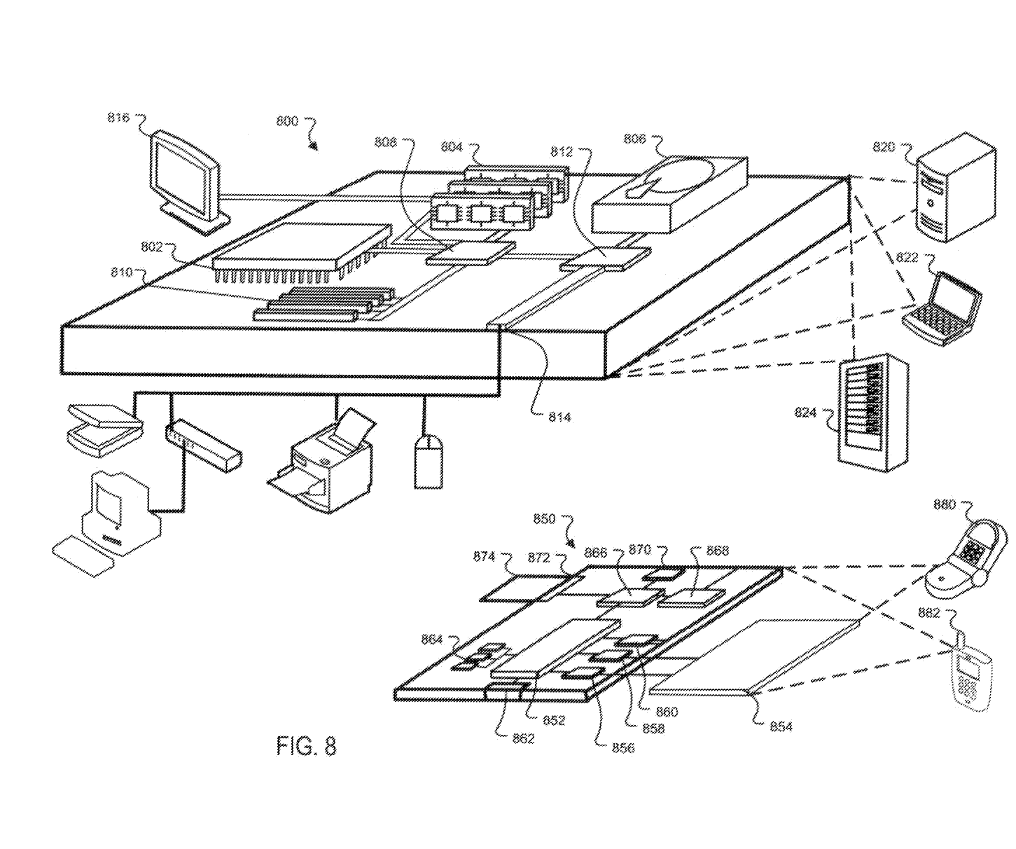

FIG. 2 is an example block diagram showing a communication between a server device (e.g., server device 150) and a client device (e.g., client device 102a-102n). The server device includes a search module 202 that may be implemented using one or more computing devices that include memory devices storing processing instructions and processing devices for executing the processing instructions. An example computing system is shown and described with reference to FIG. 8. Other computing platforms and systems, however, also are contemplated.

As discussed previously, a control element (e.g., a plusbox) may be presented that allows the user 112a-112n to manually display additional search results from the same source. When the user 112a-112n receives the initial results 204 in response to an online search (e.g., a query entered in a web browser), the initial results 204 may include results from a diverse group of sources, hosts, domains, content providers, web publishers and web sites. If it is determined that a subset of the initial results 204 is originated from a same source (e.g., the same source), the control element 216 may be displayed on the client device 102a-102n. The initial display of the control element 216 may occupy one additional line in a creative. When the user 112a-112n activates (e.g., clicks on) the control element 216, the search module 200 may return additional results 208 from the same source that are determined to be relevant to the user's query. The display of the additional results 208 may show summary information about each of the additional results 208, along with a link to the web page associated with that result. In some implementations, the additional search results are determined coincident with the initial search results, and delivered to, but hidden from, the user until the control element is activated.

As shown in FIG. 2, when the user 112a-112n issues a search query that results in the identification of the first result 212a and the second result 212b, the search module 202 may present the first result 212a and the second result 212b as the initial results 204 to the user 112a-112n. For example, the first result 212a may relate to an editorial review on a new camera model manufactured by company “X”, and the second result 212b may identify company X's landing page through which the new camera model may be purchased. The first result 212a and the second result 212b may be provided as the initial results 204 and displayed on the client device 206 as a result of a search for information related to the new camera model (e.g., searching using the name of the new camera model).

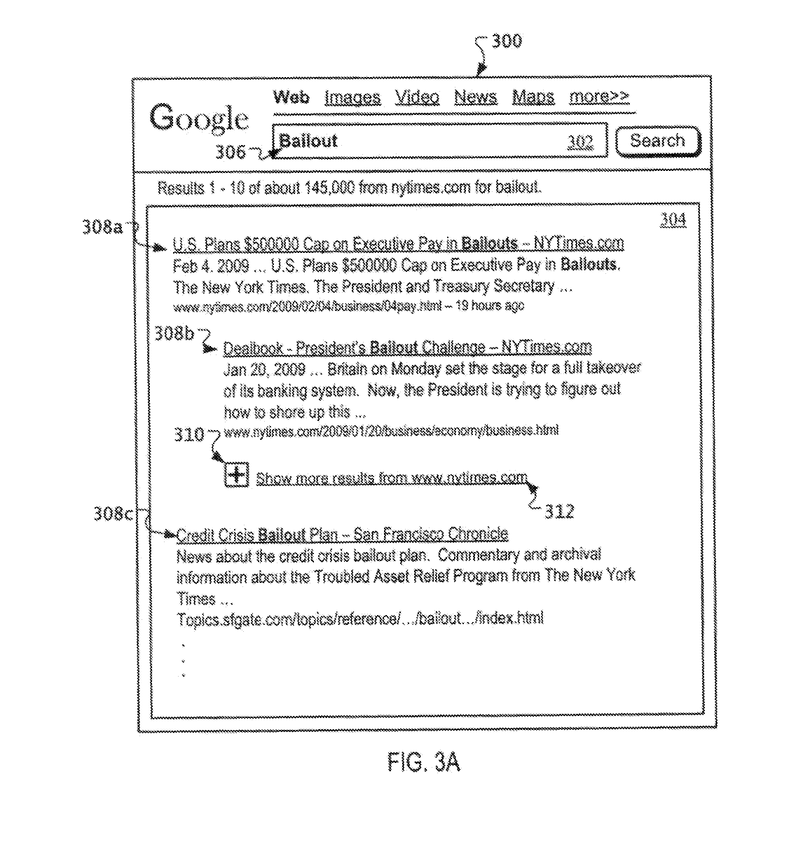

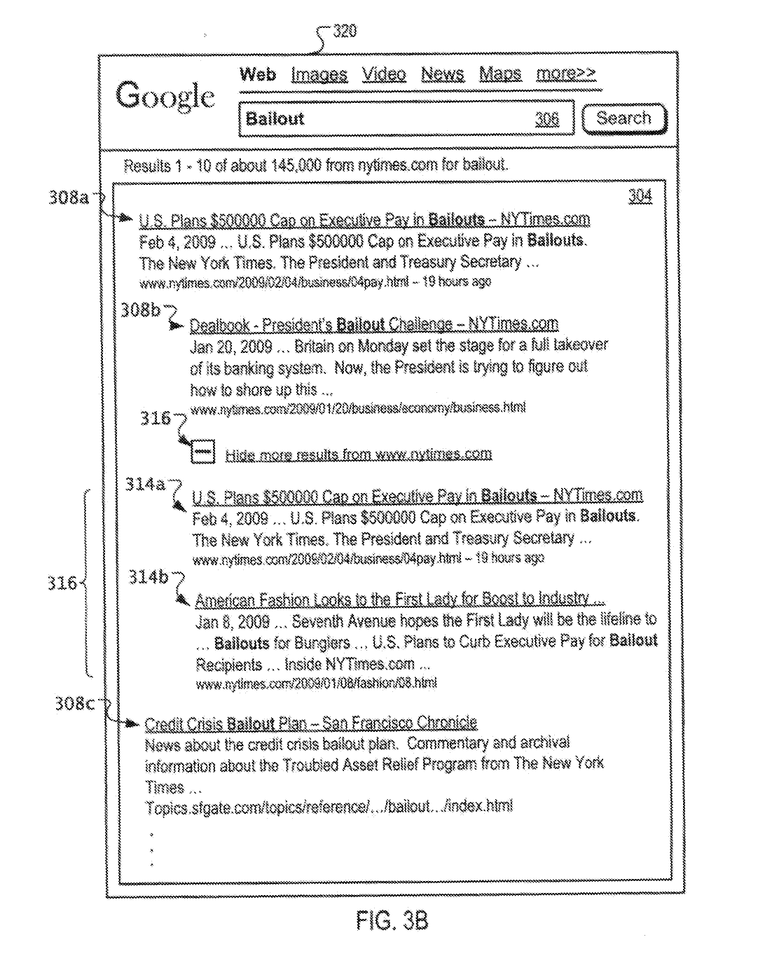

If the first result 212a and the second result 212b are from the same source or source (e.g., both results are provided by company X on company's X web site to allow consumers to view the editorial comments related to the new camera model before deciding to purchase the new camera model), both the first result 212a and the second result 212b may be displayed, and the second result 212b may be indented or identified in some other way as being from the same source, and presented below the first result 212a on the initial search results page, as will be discussed in greater detail with respect to FIG. 3. In these implementations, when additional results from the same source (e.g., same source as that associated with the first result 212a and the second result 212b) are found, the search module 202 may provide the control element 216 to be rendered on the client device 206 for presentation of the additional results. For example, the search module 202 (via the control engine 178 and display generator 180) may generate a plusbox to be displayed below the second result 212b to facilitate the presentation of the additional results.

As another example, if the first result 212a and the second result 212b are not from the same source (e.g., not from the same host, same content provider or same web publisher), and additional results related to the first result 212a and the second result 212b are separately located, both the plusbox 212a and the plusbox 212b may be rendered together with the first result 212a and the second result 212b respectively to facilitate the presentation of the additional results. For example, the user 112a-112n viewing the first result (e.g., which is linked to the editorial page published by the editorial group) on the client device 206 may open the plusbox 214a to display the additional results that are also linked to the editorial group (e.g., other camera model reviews published by the editorial group on the editorial group's web site).

In some implementations, the additional results 208 need not be sent with the initial results 204, and may be identified and stored in a memory (e.g., in a cache 216). For example, the search module 202 may pre-determine the additional results 208, and cache the pre-determined additional results 208 to the cache 216. The search module 202 may query the data store 210 as needed, and cache the additional results 208 so that the search module 202 may quickly determine whether any of the initial results 204 should include a corresponding control element (e.g., plusbox) for presentation of the additional results 208.

In some implementations, the search module 202 may bypass the caching step that pre-caches the additional results 208. For example, the search module 202 may generate the additional results 208 in real time when the user 112a-112n opens the plusbox 214a or 214b. Specifically, when the plusbox 214a or 214b is opened, an asynchronous javascript request (AJAX) may be sent from the user's browser to the search module 202 to retrieve the additional results 208. In response to the AJAX request, the search module 202 may transmit the additional results 208 (e.g., no more than five) to the client device 206 for presentation. The additional results 208 may be the results that are restricted to the same source for which the plusbox 214a or 214b is rendered, and may (or may not) omit results that arc already present on the initial search results page.

Alternatively, the additional results 208 may be pre-determined (but hidden from view) such that opening the plusbox 214a or 214b may cause the client device 206 to immediately reveal the additional results 208.

### Exemplary Screen Shots

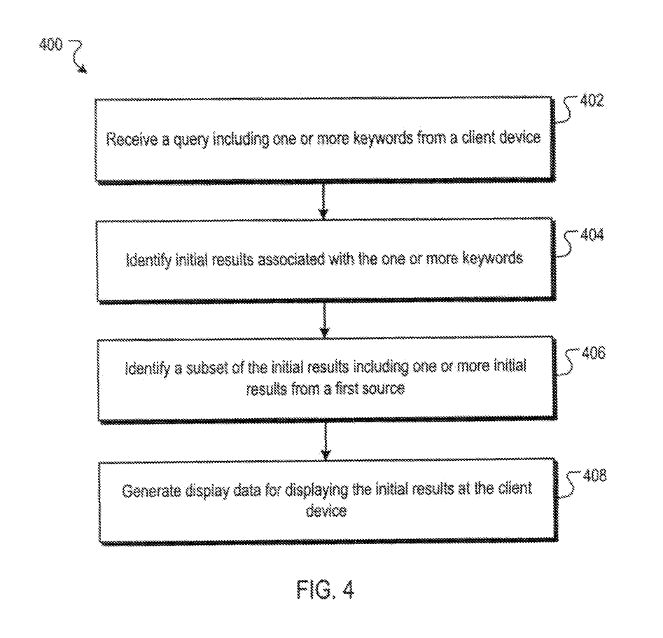

FIG. 3A is an example screen shot 300 showing a plusbox in a closed state and FIG. 3B is an example screen shot 320 showing a minusbox in an open state. Both screen shots 300 and 320 may be displayed in a user's browser on a client device (e.g., client device 102a-102n and 206), such as, without limitation, a smart phone, a personal computer, a personal digital assistant (PDA), or some other wired or wireless electronic device and the like. FIGS. 4-8 are flow diagrams of various example processes for serving and displaying the plusbox, the minusbox and the additional results. FIGS. 4-8 will now be described in reference to FIGS. 3A and 3B.

FIG. 4 is a flow diagram of an example process 400 for enabling a presentation of additional search results on a client device. Process 400 may be implemented in a system such as the system 100 shown in FIG. 1, and particularly, may be executed by a server device (e.g., server device 150).

Process 400 begins with receiving a query including one or more keywords from a client device (402). As shown in FIG. 3A, a user input field 302 may be displayed to receive a query that includes one or more keywords 306. A search results page 304 also may be displayed for displaying one or more search results generated based on the keywords entered in the user input field 302. For example, the initial search results 308a-308c displayed in the search results page 304 may be generated in response to the specific search query “Bailout” to locate information about government bailout support.

Next, initial results associated with the one or more keywords may be identified (404). Specifically, in response to the keywords 306, initial search results 308a-308c matching the query may be identified and subsequently displayed in the search results page 304. The initial search results 308a-308c may include keywords from the keywords 306, and may further highlight (e.g., by bolding, highlighting or the like) individual terms matching the search query. As depicted, the search term “Bailout” may be bolded in the initial search results 308a-308c.

A subset of the initial results including one or more initial results from a first source may be identified (406). For example, among the initial results 308a-308c, the initial results 308a and 308b may be identified as results from the same source “The New York Times”. In some implementations, the subset of the initial results may be limited to two results (e.g., results 308a and 308b)). After the subset is identified, in some implementations, additional results (e.g., results 314a and 314b shown in FIG. 3B) from the first source (e.g., “bailout” news articles published by “The New York Times”) also may be identified.

Display data for displaying the initial results at the client device 102a-102n including display data associated with the one or more initial results may be generated (408). For example, display data for displaying the initial results 308a-308c including display data associated with the two results (e.g., results 308a and 308b) from “The New York Times” may be generated. The one or more initial results may include a predetermined number of the subset of the initial results (e.g., two results). A control element 310 associated with the subset also may be presented to the client device 102a-102n to alert the user 112a-112n that additional search results 314a and 314b from “The New York Times” are available. In some implementations, the additional results may include five results, and may be displayed upon activating the control element 310.

In general, the control element 310 may be selectable by the user 112a-112n of the client device 102a-102n for enabling the presentation of additional search results 314a and 314b on the client device 102a-102n responsive to the query but restricted to the first source (e.g., restricted to “www.nytimes.com”). Activating the action prompt 312 (e.g., by clicking) may be an alternative way for the user 112a-112n to enable the presentation of the additional results.

In other implementations, a programming code (e.g., AJAX) may be executed to identify the additional search results 314a and 314b. The programming code may be executed to display the additional search results 314a and 314b without further (user) interaction with the server device 150 that is providing the display data. Alternatively, the programming code may execute a call for the additional search results 314a and 314b, and in response, the server device 150 may identify the additional search results 314a and 314b to be output to the client device 102a-102n. The display data may include a plusbox that may be displayed upon activating the control element. The plusbox may execute a call to request the additional search results 314a and 314b. After receiving the call, the server device 150 may identify the additional search results 314a and 314b.

In some implementations, an indication may be received that the user 112a-112n has activated the control element 310. Responsive to the indication, additional search results 314a and 314b associated with the one or more keywords and from the first source may be identified. For example, additional search results 314a and 314b may be generated after receipt of the indication of the activation of the control element 310 by the user 112a-112n. Alternatively, the additional search results 314a and 314b may be identified prior to receiving the indication. After receiving the indication, the initial results 308a-308c and the additional search results 314a and 314b may be delivered to the client device 102a-102n from the server device 150. The server device 150 may enable the display of only the initial results 308a-308c until the control element 310 is activated by the user 112a-112n.

As shown in FIG. 3B, the minusbox 316 may be displayed together with the additional search results 314a and 314b. The minusbox 316 may replace the plusbox 310 when the plusbox 310 is opened. After the additional search results 314a and 314b are displayed, the user 112a-112n may open the minusbox 316 to hide the additional search results 314a and 314b. Thus, opening the plusbox 310 and the minusbox 316 may expand and collapse an enlargement area 316 as desired.

In some implementations, other user interfaces or control elements may be used in addition to (or as an alternative to) the plusbox 310 and the minusbox 316. For example, the user interface may include the use of a button, an icon or other control for facilitating the display of the additional search results 314a and 314b. In another example, the user 112a-112n may simply “hover” over the initial results 308a-308c to display the corresponding additional search results 314a and 314b. For instance, the user 112a-112n may drag the mouse over the initial result 308b to display the additional search results 314a and 314b.

In general, the number of additional search results to be displayed may depend on various factors. For instance, the server device 150 may only provide additional search results that meet a certain quality threshold. The threshold may depend, for example, on the number or percentage of keywords within the result that matches the search terms in the user's original query. For example, the additional search results 314a and 314b may be those having descriptions containing keywords matching all of the terms (e.g., matching the term “Bailout”) in the user's search query.

The number of additional search results also may depend on the display criteria. For example, the number of additional search results may be limited to a number that, when displayed, does not significantly reduce the amount of display space on the user's screen. Such a display limitation may depend on the device from which the search query is submitted. For example, while a user's home computer or laptop may have a large display area capable of displaying ten additional search results, a hand-held device (e.g., smartphone, PDA, etc.) may have sufficient screen space for two to five additional search results. In some implementations, the search result area 304 may include a scroll bar or other control to facilitate the viewing of the additional search results.

In another example of limiting the number of additional search results served to the user 112a-112n, an arbitrary limit may be established so as not to overwhelm the user 112a-112n with too many additional search results. For example, the number of additional search results may be limited to a manageable number (e.g., five or less). In some implementations, an additional control element may be presented along with the additional search results to allow for the display of yet again more results that are located and associated with both the initial query and the specific source.

In some implementations, the additional search results returned and displayed on the client device 102a-102n may be ranked. For example, the ranking may be established by the number or percentage of keywords in a particular result that matches the search terms in the user's original query. Word matching may rely on processes that match different variations of words, so that, for example, a search term containing “bailout” will match the term “bailouts” in a result. Such matching may rely on fuzzy logic, grammar rules, or other processes.

In some implementations, ranking of the additional search results also may depend on information in the user's profile. For example, if the user's profile includes information indicating that the user is an Economist, the ranking system may rank an article on economic credit crisis higher than an article on university research funding. As such, the user may see the article on economic credit crisis listed first in the list of additional search results. Profile-based ranking also may use other information such as the user's gender, age, income, occupation, geographic location and interests.

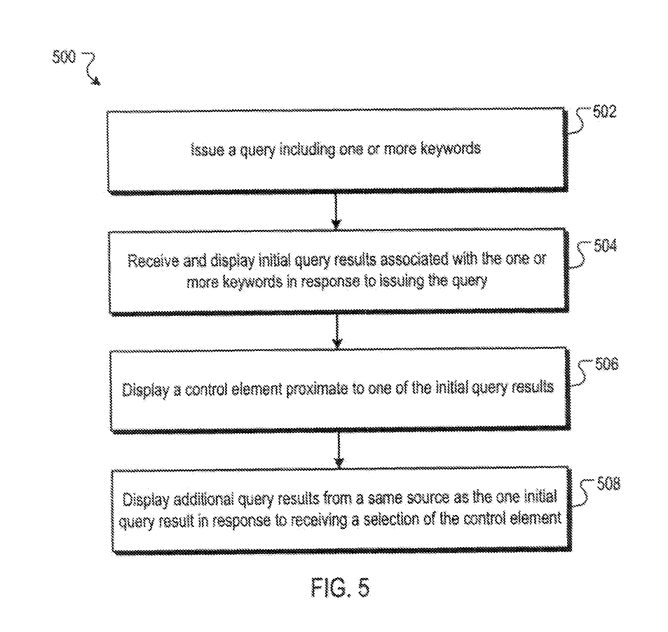

FIG. 5 is a flow diagram of an example process 500 for displaying additional search results on a client device. Process 500 may be executed by a client device (e.g., client device 102a-102n and 206).

Referring to FIG. 5, a first query may be issued including one or more keywords (502). As shown in FIG. 3A, the query may be issued through the user input field 302. In the example shown, the user 112a-112n may enter the query “Bailout” to locate information about government bailout support.

In response to the issued query, the initial query results associated with the one or more keywords may be received and displayed (504). For example, based on the query “Bailout”, initial results (e.g., generated by a server device) matching the keyword “Bailout” may be received and displayed in the search results page 304. The initial results 308a-308c may include terms that match the user's keywords. These terms may be highlighted or bolded so that the user 112a-112n may determine the relevancy and context of the initial results 308a-308c. As depicted, the search term “Bailout” may be bolded among the initial results 308a-308c.

A control element proximate to one of the initial query results may be displayed (506). For example, the plusbox 310 may be presented below the initial result 308b to alert the user 112a-112n that additional search results 314a and 314b from “The New York Times” are available. The plusbox 310 may be expandable to reveal the additional search results 314a and 314b and collapsible to hide the additional search results 314a and 314b.

In response to receiving a selection of the control element, additional query results from a same source as the one initial query result may be displayed (508). For example, upon detecting that the user 112a-112n has opened the plusbox 310, an AJAX request may be sent from the user's browser to a server device (e.g., server device 150) requesting additional search results that are site-restricted to only those published by the news agency “The New York Times”. The additional search results may (or may not) omit results that are already present on the initial search results page 304.

In some implementations, upon receiving the additional search results 314a and 314b, the additional search results 314a and 314b may be displayed in the enlargement area 316. The enlargement area 316 may be positioned in an area proximate to the corresponding initial search result. For example, the additional search results 314a and 314b may be displayed beneath the initial result 308b. The enlargement area 316 also may be collapsed upon selection of the minusbox 316 such that only the plusbox 310 (and the action prompt 312) is displayed after collapsing the enlargement area 316.

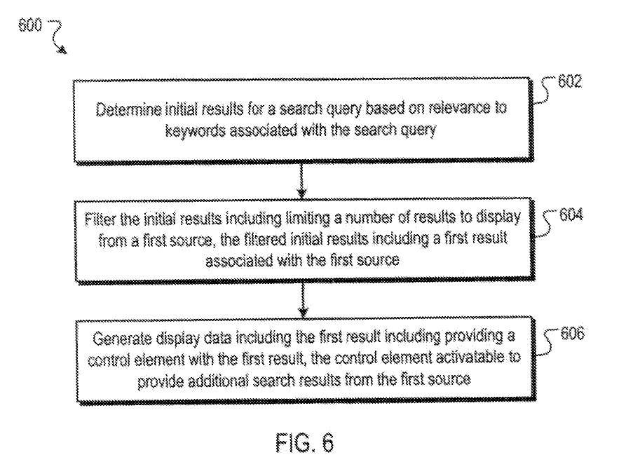

FIG. 6 is a flow diagram of an example process 600 for generating display data including a control element and additional search results. Process 600 may be implemented in a system such as the system 100 shown in FIG. 1, and particularly, may be executed by a server device (e.g., server device 150).

Process 600 begins with determining (e.g., by one or more servers or server devices) initial results for a search query based on relevance to keywords associated with the search query (602). For example, the initial results 308a-308c may be identified in response to a specific search query “Bailout” to locate information about government bailout support.

The initial results determined to be relevant may be filtered (602). In some implementations, filtering the initial results allows the number of results from a particular source (or source) to be limited. For example, if the initial results contains ten relevant results, and seven of the ten results are from the news agency “The New York Times”, the server device 150 may filter the seven results and display one (e.g., but no more than two) result from “www.nytimes.com”.

Subsequently, display data that includes the one displayed result and a control element may be generated (604). The control element may be activated to provide additional results from the first source. Using the above example, the plusbox 310 may be activated to reveal the remaining six results from the same host “www.nytimes.com”.

In some implementations, an indication that the user 112a-112n has activated the plusbox 310 may be received. In response, additional search results responsive to the search query from the first source may be determined. For example, in response to a user opening the plusbox 310, additional search results 314a and 314b from “www.nytimes.com” based on the search query “Bailout” may be determined. Once the additional search results have been determined, display data associated with the additional search results may be generated for presentation along with the first result. For example, display data associated with the additional search results 314a and 314b may be generated for presentation together with the result 308b (or result 308a). The generated display data may be transmitted to the client device 102a-102n. In some implementations, the display data associated with the additional search results may be pre-determined (at a time coincident with the initial search), delivered to a user (along with code for presenting the additional search results) and hidden from the user in the initial search results page. The additional results may be revealed when the control element is activated without any subsequent (user) interaction with the server device providing the display data.

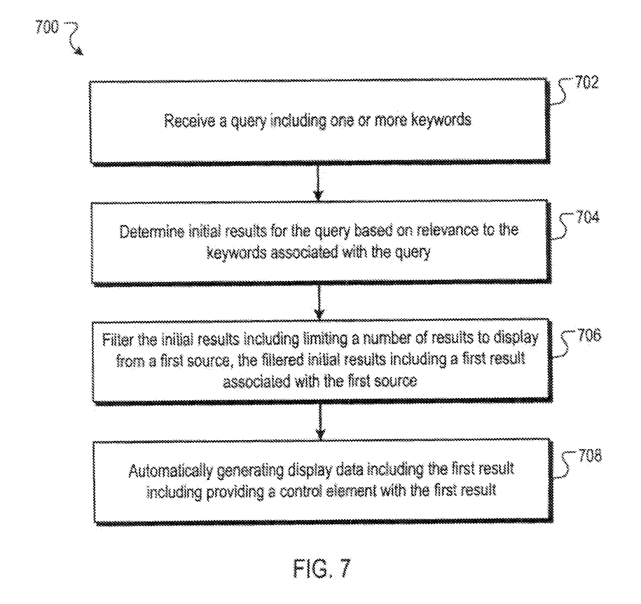

FIG. 7 is a flow diagram of an example process 700 for generating display data including a first result and a control element associated with the first result. Process 700 may be executed by a client device (e.g., client device 102a-102n and 206).

Process 700 begins with receiving (e.g., by one or more servers or server devices) a query including one or more keywords (702). For example, the query may be received through the user input field 302. As shown in FIG. 3A, the user 112a-112n may enter the query “Bailout” to locate information about government bailout support.

Initial results for the search query based on relevance to the keywords associated with the query may be determined (704). For example, the initial results 308a-308c may be identified in response to a specific search query “Bailout”. Each of the initial results 308a-308c may pertain to government bailout information published by a diverse group of sources (e.g., hosts, domains, content providers, web publishers or web sites).

The initial results may be filtered (706). In some implementations, filtering the initial results allows the number of results from a particular source to be limited. For example, if the initial results contains ten relevant results, and seven of the ten results are from the news agency “The New York Times”, a server device may filter the seven results and display one (e.g., but no more than two) result from “www.nytimes.com”.

Display data including the first result and a control element associated with the first result may be automatically generated (708). The control element may be activated to provide additional search results associated with the query that are from the first source without requiring a user of the client device 102a-102n to initiate another search. For example, the plusbox 310 may be opened. Upon opening the plusbox 310, an enlargement area 316 that contains the additional search results 314a and 314b from “www.nytimes.com” may be revealed to the user 112a-112n so that the user 112a-112n need not perform another search query in order to locate the additional search results 314a and 314b.

### Generic Computer System

FIG. 8 is a block diagram of computing devices 800, 850 that may be used to implement the systems and methods described in this document, as either a client or as a server or plurality of servers. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In-Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, memory on processor 852, or a propagated signal that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

Device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed.

What is claimed is:

1. A computer-implemented method comprising:
receiving a query including one or more keywords from a client device;
identifying initial results associated with the one or more keywords;
identifying a subset of the initial results including one or more initial results from a first source; and
generating display data for displaying the initial results at the client device including display data associated with the one or more initial results including at least a predetermined number of the subset and a control element associated with the subset,
where the control element is activatable by a user of the client device for enabling a presentation of additional search results on the client device responsive to the query but restricted to the first source.

2. The method of claim 1, further comprising:
identifying additional results associated with one or more keywords and from the first source.

3. The method of claim 1, further comprising:
receiving an indication that the user has activated the control clement; and
responsive to the indication, identifying additional results associated with the one or more keywords and from the first source.

4. The method of claim 2, where identifying the additional results associated with the one or more keywords from the first source includes searching for the additional results after receipt of the indication of the activation of the control clement by the user.

5. The method of claim 2, further comprising:
prior to receiving the indication of the activation by the user of the control element, identifying additional results associated with the one or more keywords from the first source.

6. The method of claim 5, further comprising:
delivering to the client device the initial results and the additional results; and
enabling display of only the initial results until selection by the user of the control element.

7. The method of claim 1, where the control element is an icon.

8. The method of claim 1, where the control element is a code that executes to identify the additional search results.

9. The method of claim 8, where the code executes to display the additional search results without further interaction with a server that provides the display data.

10. The method of claim 8, where the code executes a call for the additional search results, and the method further comprising:
identifying the additional search results.

11. The method of claim 8, where the display data includes a plusbox that is displayed upon selection of the control element.

12. The method of claim 11, where the plusbox executes a call to request the additional search results; and the method further includes:
receiving the call; and
responsive to the call, identifying the additional search results.

13. The method of claim 1, where the subset includes two results.

14. The method of claim 1, where the additional search results include five results.

15. The method of claim 1, where the control element is a plusbox.

16. The method of claim 1, where the display data includes a plusbox for displaying the additional results upon selection of the control element.

17. A method comprising:
issuing a query including one or more keywords;
receiving and displaying initial query results associated with the one or more keywords in response to issuing the query;
displaying a control element proximate to one of the initial query results; and
in response to receiving a selection of the control element, displaying additional query results from a same source as the one initial query result.

18. The method of claim 17, where displaying additional query results further includes displaying the additional query results in an enlargement area proximate to the one initial query result.

19. The method of claim 18, where the enlargement area is a plusbox.

20. The method of claim 19, further comprising:
expanding the enlargement area upon selection of the plusbox and displaying the additional query results in the expanded enlargement area.

21. The method of claim 20, further comprising:
collapsing the expanded enlargement area upon selection of the plusbox; and
displaying only the control element after collapsing the enlargement area.

22. A method comprising:
determining, by one or more servers, initial results for a search query based on relevance to keywords associated with the search query;
filtering, by the one or more servers, the initial results including limiting a number of results to display from a first source, the filtered initial results including a first result associated with the first source; and
generating, by the one or more servers, display data including the first result including providing a control element with the first result, the control element activatable to provide additional search results from the first source.

23. The method of claim 22, further comprising:
receiving an indication of an activation of the control element;
determining the additional search results responsive to the search query from the first source; and
generating display data associated with the additional search results for display along with the first result.

24. The method of claim 23, further comprising:
generating the display data associated with the additional search results prior to receiving the indication of activation of the control element.

25. The method of claim 23, further comprising:
transmitting the display data to a client device including transmitting but hiding the additional search results along with the display data, the control element activatable to cause the display of the additional search results to a user of the client device without subsequent interaction with a server providing the display data.

26. A system comprising:
a search system configured to provide relevant initial search results to a query, the search system including:
a query engine to receive the query including one or more keywords from a client device and identify relevant initial results associated with the one or more keywords;
a filter for providing a limited number of initial results from a first source producing filtered initial results;
a control engine that generates a control element associated with the first source, the control element activatable to identify additional query results associated with the first source; and
a display generator that generates display data for displaying the filtered initial results and the Control element, and provides the display data including the control element to the client device.

27. A method comprising
receiving a query including one or more keywords;
determining, by one or more servers, initial results for the query based on relevance to the keywords associated with the query;
filtering, by one or more servers, the initial results including limiting a number of results to display from a first source, the filtered initial results including a first result associated with the first source; and
automatically generating, by one or more servers, display data including the first result including providing a control element with the first result, the control element activatable to provide additional search results associated with the query that are from the first source without requiring a user of the client device to initiate another search.
